(19) United States
(12) Patent Application Publication
(10) Pub. No.: US 2017/0308516 A1
(43) Pub. Date: Oct. 26, 2017

(54) EMAIL IMAGE ATTACHMENT ALBUM CURATION

(71) Applicant: Microsoft Technology Licensing, LLC., Redmond, WA (US)

(72) Inventors: Hayley Lynn Steplyk, Redmond, WA (US); Rebecca Jean Lawler, Bellevue, WA (US); Joseph Patrick Masterson, Issaquah, WA (US)

(73) Assignee: Microsoft Technology Licensing, LLC., Redmond, WA (US)

(21) Appl. No.: 15/249,199

(22) Filed: Aug. 26, 2016

Related U.S. Application Data
(60) Provisional application No. 62/327,617, filed on Apr. 26, 2016.

(51) Int. Cl. G06F 17/24; G06F 3/0484; G06F 3/0485; G06T 11/60; H04L 12/58; H04L 29/08; G06F 3/0482

(52) U.S. Cl. CPC G06F 17/241; G06F 3/04845; G06F 3/04847; G06F 3/0485; H04L 67/02; G06T 11/60; H04L 51/22; H04L 51/08; G06F 2203/04804; G06F 3/0482; G06T 2200/24; G06F 2203/04806

(57) ABSTRACT

Email is a widely adopted communication tool, but is awkward for dealing with large numbers of attachments, especially when the sender wishes to draw the receiver's attention to certain portions of those attachments or to present the attachments in a set order. Therefore, the present disclosure provides systems and methods for creating and managing a single attachment object within an email application to enforce a curated experience for the receiver in the receiver's email application. By providing a single attachment object that comprises and curates multiple component files, an improved user experience is realized for both sender and receiver, and less data need to be transmitted and fewer computing resources expended to provide the curated experience.

### CROSS-REFERENCES TO RELATED APPLICATIONS

The present application claims benefit from U.S. Provisional Application No. 62/327,617 filed on Apr. 26, 2016 and having the title “EMAIL IMAGE ATTACHMENT ALBUM CREATION,” which is herein incorporated by reference in its entirety.

### BACKGROUND

Email is a widely adopted tool for persons to communicate electronically with one another. When email users wish to send more than text in the body of a message to one another, additional files may be inserted into the email message. Such files may include word processor documents, spreadsheet documents, presentation documents, compressed files, sound files, and images. Image sharing is particularly laborious, for both sender and receiver, particularly as the number of image files that the sender wishes to share grows. The sender often attaches each file individually and is reliant on the receiver opening and interpreting each image on their own; the desired order of viewing, or focus, is left to the receiver, who may miss the effect desired by the sender.

To enforce a curated experience, in which the receiver views the images in an order desired by the sender, the sending user may turn to online image hosting or social media websites to create albums, such as, for example, Facebook® (available from Facebook Inc., of Menlo Park, Calif.), Imgur@ (available from Imgur LLC, of San Francisco, Calif.), and Google Drive™ (available from Alphabet Inc., of Mountain View, Calif.). In addition to this curation not being done within an email client, requiring the sender to use a hyperlink to the third party host if the album is to be shared via an email message, album creation in a social media website or image host requires the laborious uploading of multiple images by the sender into the web interface of the third party host, and the expenditure of computer memory and processing resources to transmit (from sender, third party host, and receiver) for the uploading, the storing, and the retrieval of the images for display as part of the curated album.

A sender may also try to enforce a curated experience, in which the receiver views selected portions of the image (e.g., those portions having special importance), by editing the images or attaching explanatory files. For example, a sender may use an image editing application to draw a circle around a desired portion of the image, use pen input to write on the image, or crop the image to draw attention to the desired portion. In another example, a user may attach instructions for what the receiver is supposed to notice in each image or an order in which to view the images, which requires additional applications to be opened to convey the instructions and the receiver to pay heed to the instructions. Aside from the possibility of the receiver ignoring or not noticing instructions, the inclusion of instructions may diminish the usefulness of an image (or require a “clean” version to be sent in addition to an annotated version) and require additional files to be attached with the email; further expending computing resources to transmit the instructions, which may be of marginal value.

### SUMMARY

This summary is provided to introduce a selection of concepts in a simplified form that are further described below in the Detailed Description section. This summary is not intended to identify all features of the claimed subject matter, nor is it intended as limiting the scope of the claimed subject matter.

Systems and methods are provided herein for enabling the curation of albums of images attached with an email. As a sending user who wishes to attach images to an email will be prompted as to whether an album should be created or whether the user wishes to attach a multitude of individual images. The album is a single file, which may correspond to a folder in the sending user's file system, that the receiving user may open to view the images of which the album is comprised in a curated manner. The sending user may specify various curations for the album which will affect how it is consumed by the receiving user, such as, for example: orders of images, graphical and text annotations for the images, sound annotations for the images, zooming and panning instructions, and relational data for the images.

By providing users with the ability to send and receive curated albums via email instead of a mass of individual images, not only will the user experience (both sending and receiving) be improved, but the efficiency of computing systems used in sharing images will also be improved by allowing the sender to forego using a third party host or relying on the receiver to notice and follow instructions, and reduce the amount of data needed to be transmitted to ensure a curated experience for the receiver.

The details of one or more aspects are set forth in the accompanying drawings and description below. Other features and advantages will be apparent from a reading of the following detailed description and a review of the associated drawings. It is to be understood that the following detailed description is explanatory only and is not restrictive; the proper scope of the present disclosure is set by the claims.

### BRIEF DESCRIPTION OF THE DRAWINGS

The accompanying drawings, which are incorporated in and constitute a part of this disclosure, illustrate various aspects of the present disclosure. In the drawings:

FIG. 1 illustrates an example environment in which album curation may be implemented;

FIG. 2 illustrates an example of initiating the creation and curation of an album attachment from a file system;

FIGS. 3A and 3B illustrate various aspects of the creation and curation of an album attachment, illustrating example controls and example annotations respectively;

FIGS. 4A-4E illustrate an example viewing of the album attachment discussed in regard to the examples illustrated in FIGS. 3A and 3B in several curated steps;

FIG. 5 is a flowchart showing general stages involved in an example method for enabling the curation of albums of images attached with an email;

FIG. 6 is a flowchart showing general stages involved in an example method for a receiving user interacting with a curated album of images attached with an email;

FIG. 7 is a block diagram illustrating physical components of a computing device with which examples may be practiced;

FIGS. 8A and 8B are block diagrams of a mobile computing device with which aspects may be practiced; and

FIG. 9 is a block diagram of a distributed computing system in which aspects may be practiced.

### DETAILED DESCRIPTION

The following detailed description refers to the accompanying drawings. Wherever possible, the same reference numbers are used in the drawings and the following description to refer to the same or similar elements. While aspects of the present disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the present disclosure, but instead, the proper scope of the present disclosure is defined by the appended claims. Examples may take the form of a hardware implementation, or an entirely software implementation, or an implementation combining software and hardware aspects. The following detailed description is, therefore, not to be taken in a limiting sense.

Systems and methods are provided herein for enabling the curation of albums of images attached with an email. As a sending user who wishes to attach images to an email will be prompted as to whether an album should be created or whether the user wishes to attach a multitude of individual images. The album is a single file, which may correspond to a folder in the sending user's file system, that the receiving user may open to view the images of which the album is comprised in a curated manner. The sending user may specify various curations for the album which will affect how it is consumed by the receiving user, such as, for example: orders of images, graphical and text annotations for the images, sound annotations for the images, zooming and panning instructions, and relational data for the images.

By providing users with the ability to send and receive curated albums via email instead of a mass of individual images, not only will the user experience (both sending and receiving) be improved, but the efficiency of computing systems used in sharing images will also be improved by allowing the sender to forego using a third party host or relying on the receiver to notice and follow instructions, and reduce the amount of data needed to be transmitted to ensure a curated experience for the receiver.

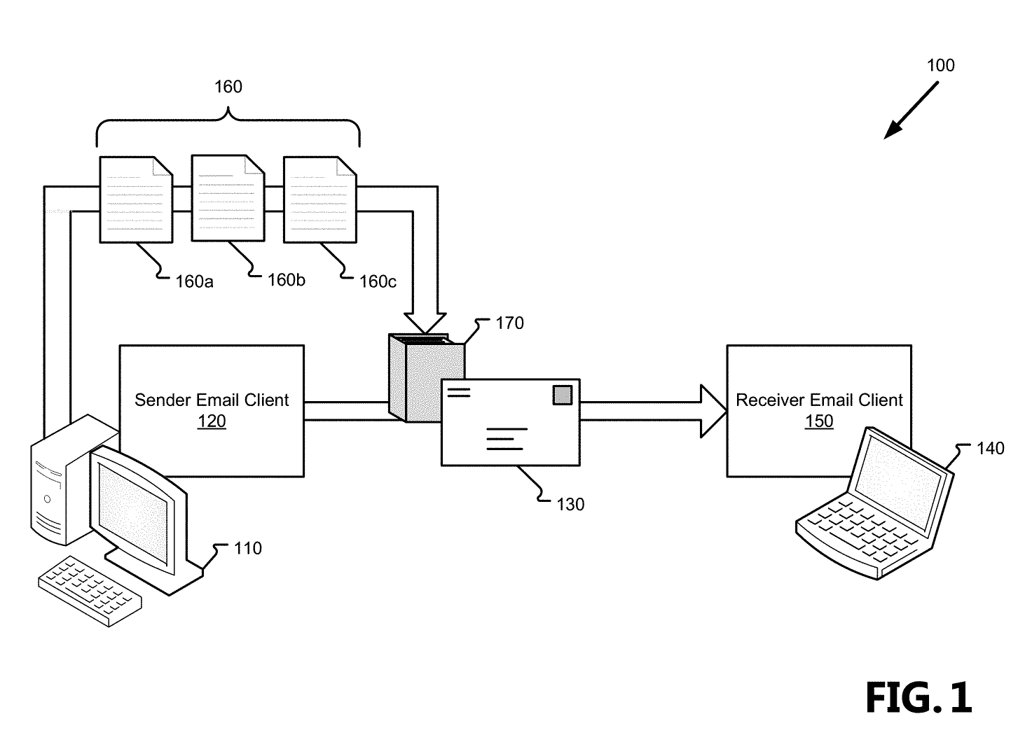

FIG. 1 illustrates an example environment 100 in which album curation may be implemented. As illustrated, a sender machine 110 is running a sender email client 120, which is sending an email message 130 that will be received by a receiver machine 140 via a receiver email client 150. Files stored on, or accessed by, the sender machine 110 are added to the email message 130 as attachments, and may include curated files 160 (individually, first curated file 160a, second curated file 160b, third curated file 160c, etc.) that are organized into an album attachment 170, which is sent to the receiving user to provide a curated experience in viewing the curated files 160.

Although not illustrated, one of skill in the art will appreciate that various email servers and intermediaries in a network may lie between the sender machine 110 and the receiver machine 140 to route the email message 130 between the sender and the receiver, and a sender or a receiver may access the email message 130 from multiple machines linked to those servers (e.g., on a mobile computing device and on a desktop computing device).

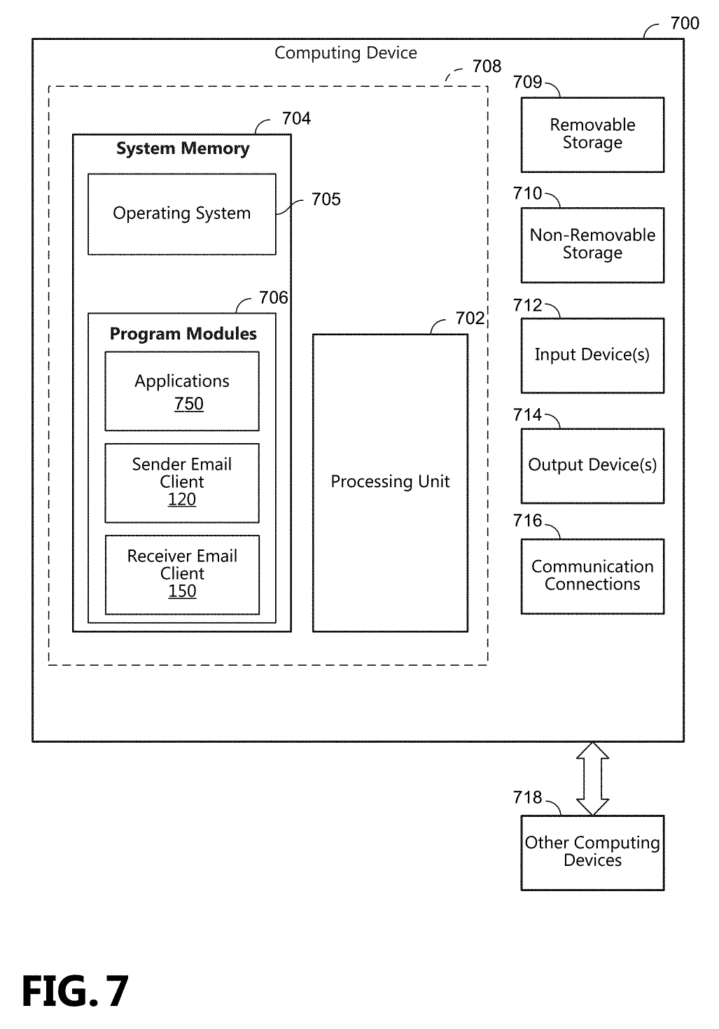

The sender machine 110 and receiver machine 140 are illustrative of a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers. The hardware of these computing systems is discussed in greater detail in regard to FIGS. 7, 8A, 8B, and 9. In various aspects, the sender machine 110 and receiver machine 140 are accessed locally and/or by a network, which may include the Internet, a Local Area Network (LAN), a private distributed network for an entity (e.g., a company, a university, a government agency), a wireless ad hoc network, a Virtual Private Network (VPN) or other direct data link (e.g., Bluetooth connection, a direct wired link).

The sender email client 120 and the receiver email client 150 used to send and receive the email message 130 are illustrative of a multitude of programs and applications used to send and receive email, including, without limitation, local applications and cloud-based applications, such as for example: Gmail™ (offered by Alphabet, Inc.), Thunderbird® (offered by the Mozilla Foundation of Mountain View, Calif.), or Outlook® (available from Microsoft Corp. of Redmond, Wash.). In various aspects, the sender email client 120 and the receiver email client 150 may be different instances of the same application or program, or they may be unique instances of different applications or programs.

The email message 130 may be composed, formatted, transmitted, and received according to various standards (and various versions thereof), including, but not limited to: POP (Post Office Protocol), IMAP (Internet Message Access Protocol), MIME (Multipurpose Internet Mail Extension), SMTP (Simple Mail Transfer Protocol), HTML (Hypertext Markup Language), Rich Text, Plain Text, etc.

The curated files 160 may be formatted according to various image standards and as various file types and extensions, including, but not limited to: bitmaps, joint picture expert group (jpeg), graphics interchange format (gif), portable network graphics (png), tagged image file format (tiff), scalable vector graphics (svg), and digital negatives (dng). A given curated file 160 may be of the same or different format from the other curated files 160 in the album attachment 170. Each of the curated files 160 may be compressed, if their format allows for compression, may be annotated by the sending user, and may be extracted from the album attachment 170 by the receiving user (with or without the annotations). The curated files 160 may be stored locally on the sender machine 110 or may be accessed remotely by the sender machine 110 on an external hard drive, a networked hard drive, or a cloud storage solution, such as, for example, Google Drive™ (available from Alphabet Inc.), Amazon Cloud Drive™ (available from Amazon.com Inc., of Seattle, Wash.), or OneDrive® (available from Microsoft Corp.).

The album attachment 170 is sendable and receivable as a single file in the email message 130. In various aspects, the album attachment 170 is a formatted HTML object that is sent with the email message 130 that enables the receiving user to see the curated experience designed by the sending user as the sending user saw the curated experience. In other aspects, the album attachment 170 may be formatted as an online HTML object to which the email message 130 include a hyperlink for, or as a self-executing file. The album attachment 170 may be displayed in a separate pane from where the receiving user views the body of the email message 130, a separate window, or in a frame within the body of the email message, depending on the capabilities of the receiver email client 150. The receiving user may also download the album attachment 170 as an object to a storage solution (local or remote to the receiver machine 140) and/or extract the curated files 160 that comprise the album attachment 170 (with or without annotations). In addition, any annotations (e.g., sound recordings, text, image masks) and metadata may be stored as separate files within the album attachment 170, and the sending user, in various aspects, may include non-image files with the album attachment 170, although those files will not be annotated or curated as image files may be.

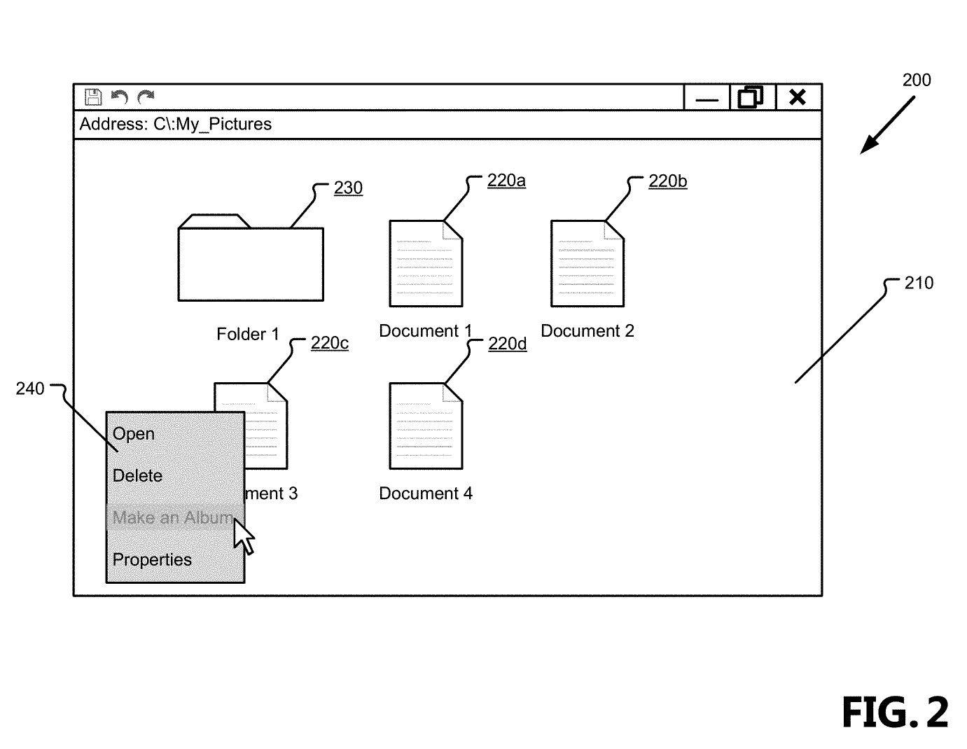

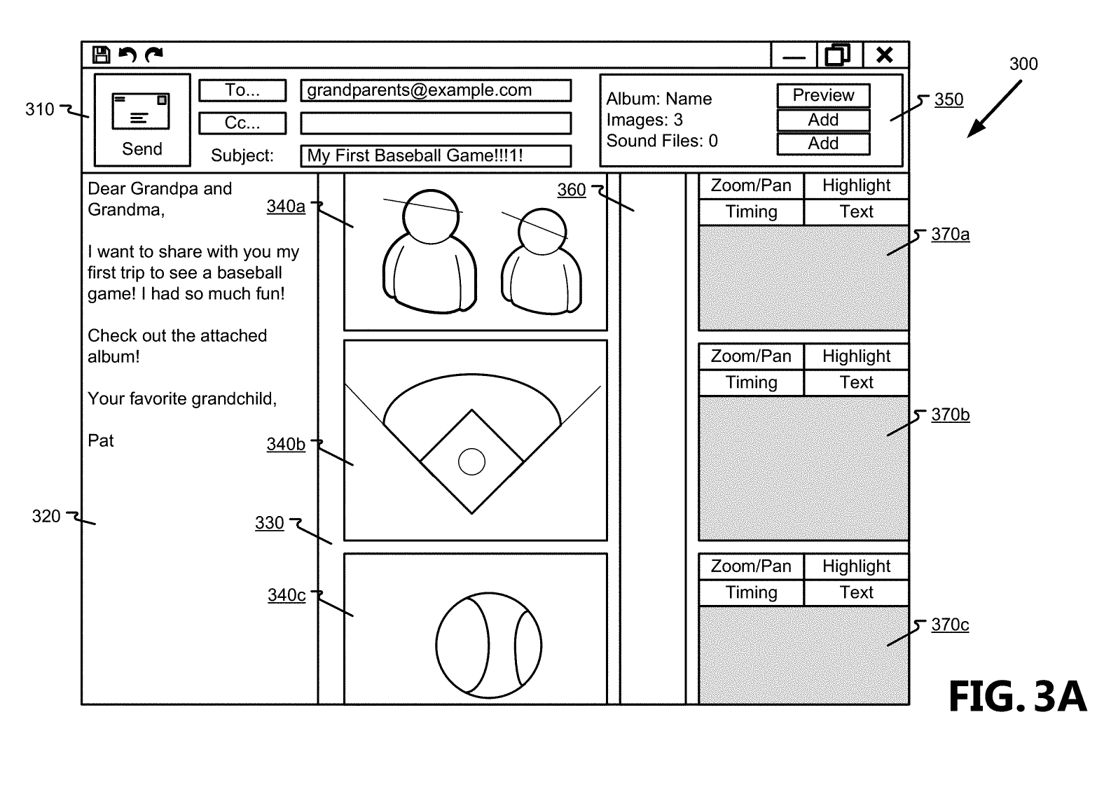

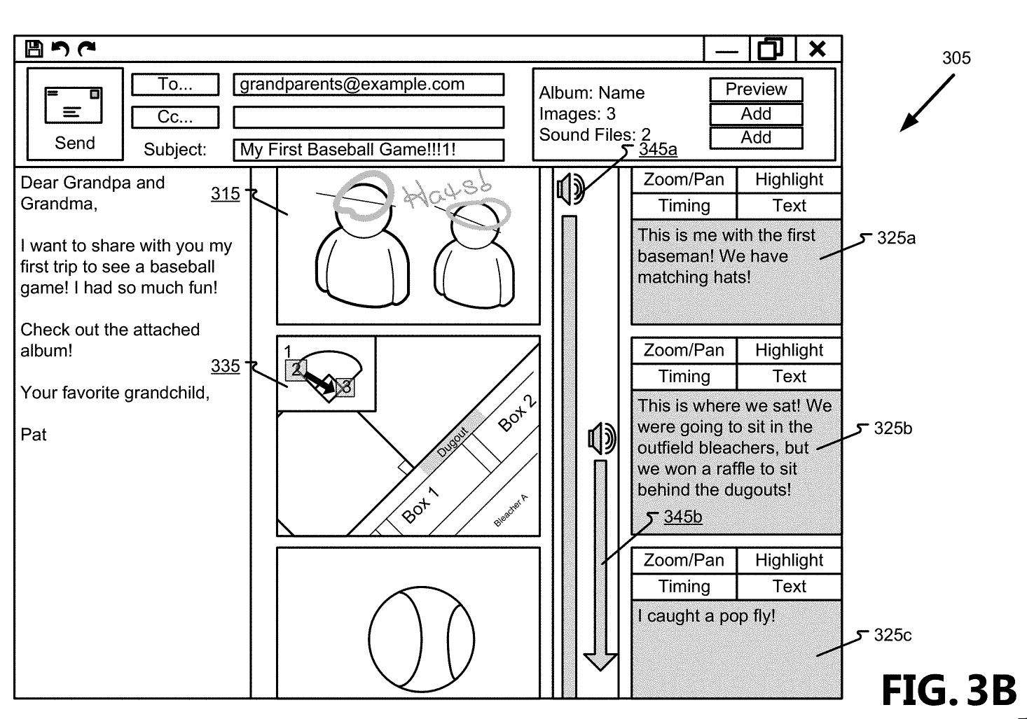

When creating the album attachment 170, the sending user may begin the album creation process by selecting files from a file system (as discussed in relation to FIG. 2), manually drag and drop or attach files via the sender email client 120 as part of a user-initiated or system-initiated initiated album creation process, or attach a file path or Uniform Resource Locator (URL) for a collection of files. The sender email client 120 will provide windows and/or panes for editing the album attachment 170 so that the sending user may curate the curated files 160 by ordering and annotating the curated files 160 and the album attachment 170 as a whole (as discussed in relation to FIGS. 3A and 3B). By structuring the album attachment 170 as an HTML object (or as a self-executing file), the functionality to build and curate the album attachment 170 may be localized to the sender email client 120 and the end result of the curated experience may be enjoyed by the receiving user even if the receiver email client 150 lacks the functionality to create and curate album attachments 170.

FIG. 2 illustrates an example 200 of initiating the creation and curation of an album attachment 170 from a file system. As will be appreciated, the User Interfaces (UI) illustrated and discussed are explanatory, and do not limit the scope of the present disclosure in the inclusion or exclusion of discussion of various components; one of ordinary skill in the art will appreciate additional elements that may be added or elements that may be removed or rearranged from those shown in FIG. 2 without departing from the scope of the present disclosure.

As illustrated, a graphical user interface (GUI) for a file location 210 includes a plurality of files represented as folder icons 230 and file icons 220 (individually, first file icon 220a, second file icon 220b, third file icon 220c, fourth file icon 220d, etc.). File locations may be local to the sender machine 110, on a cloud service provider, or a website (via a URL), and the file icons 220 represent electronic documents of various types, including image files.

When a user has selected multiple files, by selecting multiple file icons 220, a folder icon 230 representing a file location containing multiple files, or a combination thereof, the user may be presented with a contextual menu 240 with the option to “make an album” from the files included in the selection, if multiple images suitable for use as curated files 160 are present. In various aspects, the contextual menu 240 will not provide the option to “make an album” (or the option will be grayed out and unselectable) unless a threshold number of suitable image files have been selected, and this threshold may be configured by the user to be various numbers (e.g., one, seven, twenty-eight).

The system providing the GUI by which the file location 210 is displayed or the contextual menu 240 is provided may determine that a file is a suitable image based on the file type extension matching a file type for an image file type which the sender email client 120 is capable of including as a curated file 160 in an album attachment 170. A non-exhaustive list of extensions that are used in association with suitable for images include, but are not limited to: .gif, .gifx, .gifv, .jpg, .jpeg, .jfif, .exif, .bmp, .bmpx, .tif, .tiff, .png, .svg, .raw, .ppm, .pgm, .pbm, .pnm, .webp, .hdr, .heif, .cd5, .ecw, .img, .cpt, .psd, .psp, .xcf, .cdr, and other file extensions for image file types, which one of ordinary skill in the art will recognize. Selected files that are not images that the sender email client 120 can handle as curated files 160 may be ignored by the sender email client 120 when a user selects the “make an album” option from the contextual menu 240, or may be automatically added as attachments separate from the album attachment 170 to the email message 130.

To illustrate, consider the first file icon 220a to represent a word processor document; the second file icon 220b, the third file icon 220c, and the fourth file icon 220d to represent suitable image files; and the folder icon 230 to represent a storage location including three suitable image files. If the threshold to present the “make an album” option is three image files, a user who selects the folder icon 230, all three of the file icons 220b-d representing image files, or the folder icon 230 and any of the file icons 220 would be presented with the option to “make an album” in the contextual menu 240 when it is summoned. On selecting the “make an album” option from the contextual menu 240, the sender email client 120 may initiate the album curation process so that the user may curate the image files and send them in an email to a receiving user.

FIGS. 3A and 3B illustrate various aspects of the creation and curation of an album attachment, illustrating example controls 300 and example annotations 305 respectively. As will be appreciated, the UIs illustrated and discussed are explanatory, and do not limit the scope of the present disclosure in the inclusion or exclusion of discussion of various components; one of ordinary skill in the art will appreciate additional elements that may be added or elements that may be removed or rearranged from those shown in FIGS. 3A and 3B without departing from the scope of the present disclosure.

FIG. 3A illustrates example controls 300 for an album creation and curation mode of a sender email client 120. As illustrated, email client controls 310 are provided for addressing, sending, saving, labeling, etc., the email message 130 with which the album attachment 170 is to be transmitted. Similarly, a message authoring panel 320 is provided for the sending user to author an email message 130, and may include text enrichment controls (e.g., bold, italic, underline, text color, text size, typeface). One of ordinary skill in the art will be familiar with email client controls 310 and message authoring panels 320 in the context of an email client.

An album building panel 330 is provided within the sender email client 120 to enable a user to create and curate the curated files 160 comprising an album attachment 170 within the sender email client 120. Although illustrated as part of a panel for authoring an email message 130, in other aspects, the album building panel 330 may be provided in a separate window, or in a panel of the sender email client 120 that is unrelated to an individual email message 130. The album building panel 330 displays image previews 340 (individually, first image preview 340a, second image preview 340b, third image preview 340c, etc.), which the sending user may manipulate to change the order of the curated files 160 comprising the album attachment 170 and view the images that comprise the curated album. The sending user may drag and drop additional image files into the album building panel 330 to add them to the album attachment 170 or may use the album controls 350 to add additional curated files 160 to the album attachment 170.

The album controls 350 include controls and indicators that relate to the album attachment 170 as a whole. Such controls include initiating a preview mode, where the sending user can view what the curated experience will look like to the receiving users, a file size indicator (number of files, size in kilobytes/megabytes), add and delete image controls, add and delete sound file controls (from a preexisting file or make a new recording), add and delete pen input controls, add and delete text controls, text editing controls (may be shared with sender email application controls), album and file name controls, etc.

Cross-image controls 360 enable a user to control how annotations interact across images in the curated experience and how images transition in the curated experience. For example, where x>y, a user may set a sound file to play for x seconds and for a given image to be displayed for y seconds via the cross-image controls 360 so that the sound file will play while the first given image is displayed and continue to play when a subsequent image is displayed. Similarly, transitions and animations (e.g., fade, morph, star swipe) between the images in the curated experience may be set via the cross-image controls 360. The transitions may specify a pace at which to automatically display the next image file, that user input is required to proceed to the next image file, or to proceed in response to an annotation completing (e.g., wait until an audio file is complete).

Image controls 370 enable a user to control how annotations and effects are applied to an individual curated file 160. For example, a first image control 370a corresponding to a first curated file 160a, a second image control 370b corresponding to a second curated file 160b, a third image control 370c corresponding to a third curated file 160c, etc., would enable a user to see and modify the annotations, durations, and effects applied to a single corresponding image. In various aspects, the image controls 370 allow a user to add, format, and delete text, highlighting (e.g., via pen input), pan and zoom commands, and timing commands to the images within the curated experience. In other aspects, the user may use a single set of image controls 370 that will affect a selected (or multiple selected) images from the album building panel 330.

As will be appreciated, the controls shown in FIG. 3A are but one aspect, and other groupings with more or fewer controls are also possible, and controls appearing in one of the album controls 350, cross-image controls 360, and image controls 370 may appear in a different one of the album controls 350, cross-image controls 360, and image controls 370 in different aspects.

FIG. 3B illustrates example annotations 305 on curated files 160 in using the example controls 300 of the sender email client 120 illustrated in FIG. 3A. For purposes of clarity, the example controls 300 are not labeled in FIG. 3B, although one of ordinary skill the art will recognize the controls from FIG. 3A.

Pen annotations 315 enable the user to write on the image using natural user input (NUI), such as a touchscreen, or a mouse with a pen tool, to add freeform input. The freeform input may take the form of handwriting, highlighting, or drawings. In various aspects, the sender email client 120 will save the freeform input as a second image or as a second layer to the curated file 160 to which it is applied. The annotations are dimensioned according to the dimensions of the curated file 160 and may be applied as a mask to the curated file 160 when it is displayed as part of the curated experience so that both are displayed as part of the curated experience with the mask overlaying the image, with transparencies for areas not affected by pen annotations 315. When the sending receiver extracts the curated files 160, the masks may be included or excluding in the extraction so that the sending receiver can get the file in its original form or in a form with the pen annotations 315 included.

Text annotations 325 enable the user to add text to be displayed, in a separate pane or as an overlay, to the curated file 160. The text may be in plaintext or richtext, having various typefaces, colors, sizes, and text effects. In various aspects, the text annotations 325 may be saved as text files within the album attachment 170 or may be integrated as text in an element definition for an image for a curated file 160.

Zoom and pan annotations 335 enable the user to increase and decrease the level of zoom in an image, and when only a portion of the image is displayed by the user machine, to determine which portion is displayed. As will be appreciated, as the image is zoomed and panned, various transitions may be applied to smooth the transition from one display state to the next, or the states may jump from one to the next. In various aspects, when an image includes zoom and pan annotations 335, they may be indicated in a preview thumbnail that indicates an order and area of the original image which will be shown. In other aspects, the different states of zoom and pan annotations may be indicated as images in the order of the album building panel 330 like the images of the curated files 160 or as smaller versions, similarly to the images of the curated files 160.

Sound annotations 345 enable the user to add sound files to be played back at various points of the curated experience. The sound files may be preexisting files (such as mp3 files, wave files, etc.) or may be recorded specifically for the album attachment 170. For example, a user may set a first sound annotation 345a to run the course of the curated experience (e.g., a song to play in the background) and a second sound annotation 345b to play during or across the display of various images in the curated experience. The sound files that encode the sound annotations 345 are included in the album attachment 170 and in various aspects may be extracted along with the curated files 160 or may be unextractable as files from album attachment 170.

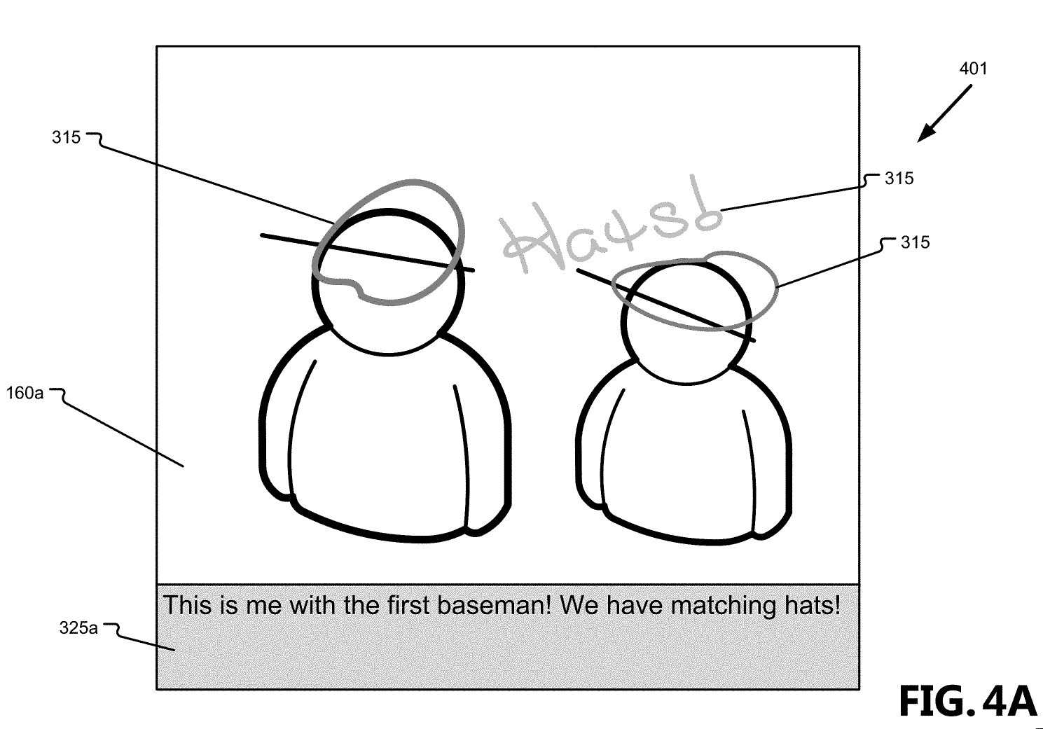

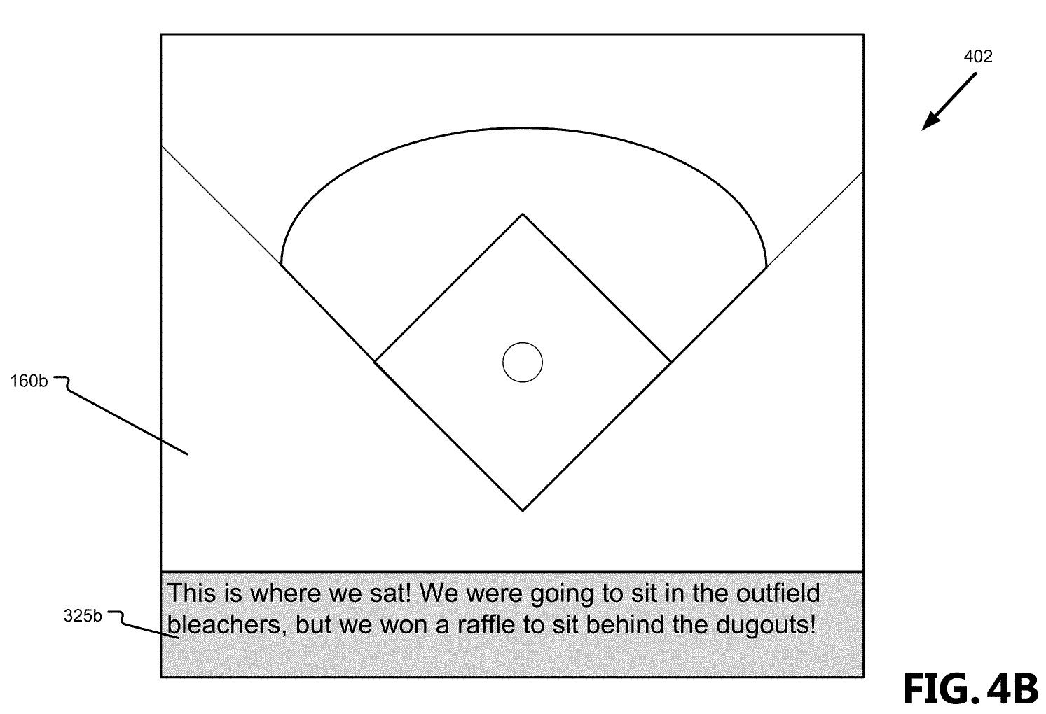

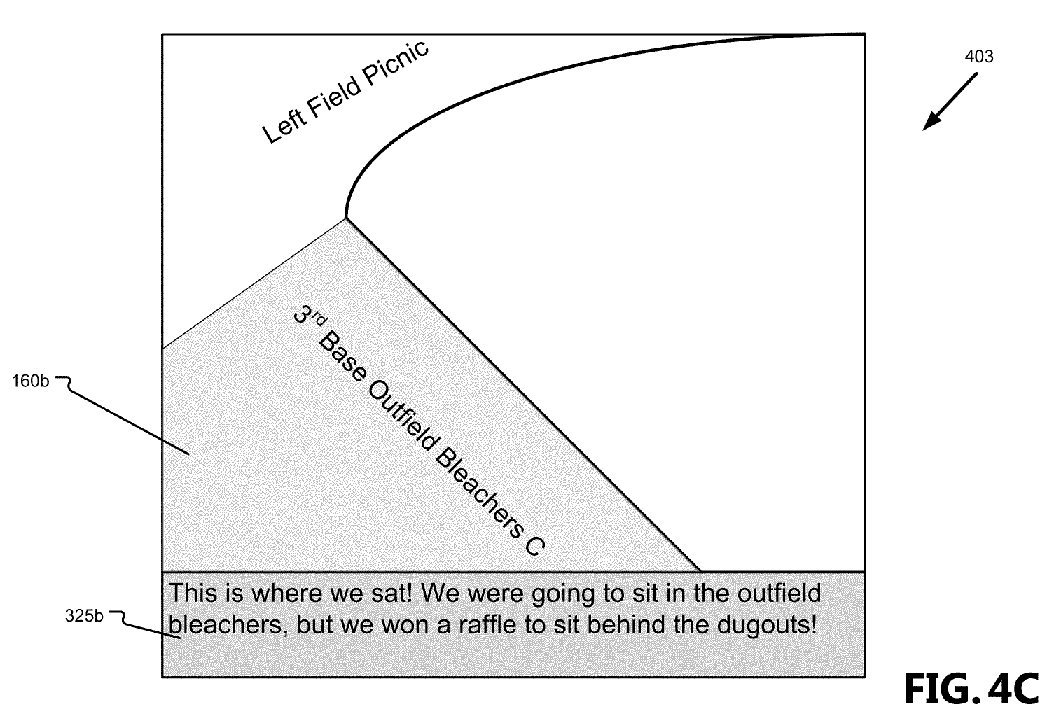

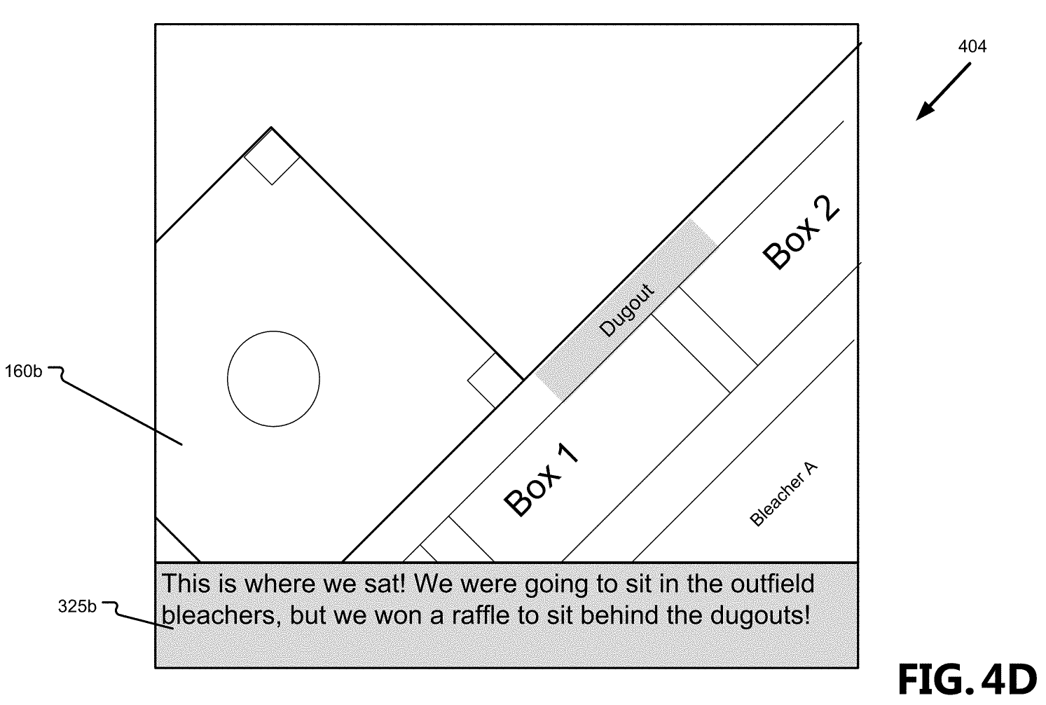

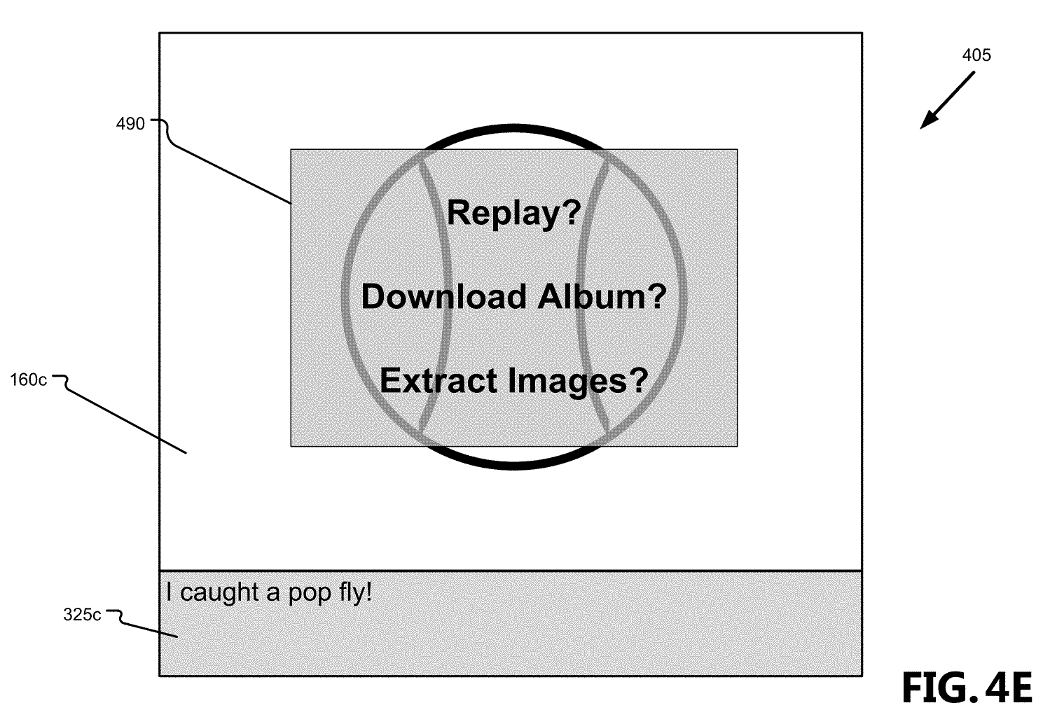

FIGS. 4A-4E illustrate an example viewing of the album attachment 170 discussed in regard to the examples illustrated in FIGS. 3A and 3B in several curated steps 401-405. As will be appreciated, the UIs illustrated and discussed are explanatory, and do not limit the scope of the present disclosure in the inclusion or exclusion of discussion of various components; one of ordinary skill in the art will appreciate additional elements that may be added or elements that may be removed or rearranged from those shown in FIGS. 4A-4E without departing from the scope of the present disclosure.

The curated steps 401-405 illustrated in FIGS. 4A-4E may be displayed in response to a sending user viewing the curated album attachment 170 in a preview mode or a receiving viewer consuming the curated album attachment 170. As will be appreciated, the album attachment 170 may be previewed or consumed in the email client in a new pane or a new window, a web browser or other compatible program, as a self-executed file, and may be viewed in a windowed or fullscreen mode thereof.

FIG. 4A illustrates a first curated step 401 in which the first curated file 160a and its associated annotations are displayed to the user. Text annotations 325a associated with the first curated file 160a are displayed (either as an overlay of the first curated file 160a or in a separate pane), sound annotations 345 associated with the image or with the image's position in the curated album attachment 170 are played, and pen annotations 315 are displayed as a layer on top of the curated file 160 so that the sending user's annotations may be displayed over the relevant portion of the image, but do not have to be saved as edits to the curated file 160; reducing the amount of data that need to be transmitted or retained to preserve the original image and display the sending user's annotations.

FIGS. 4B, 4C, and 4D illustrate second curated step 402, third curated step 403, and fourth curated step 404, respectively, to illustrate an example zoom and pan annotation. As illustrated, the same text annotations 325 associated with the second curated file 160b are shown in all three curated steps 402-404, but different text annotations 325 may be shown in different aspects, if the sending user sets specific text to show with specific zoom and pan states.

In FIG. 4B, illustrating the second curated step 402, the initial zoom and pan state for the second curated file 160b is shown, along with any other annotations associated with that state (none illustrated) being shown or executed (e.g., sound files). Similarly, in FIGS. 4C and 4D, for the third curated step 403 and the fourth curated step 404 respectively, the second and third zoom and pan states for the second curated file 160b and any other associated annotations are shown or executed. The image illustrated may jump from that shown in FIG. 4B to that shown in FIG. 4C, or an intra-image transition (morphing animation, fade, slide, etc.) may be performed on the transition from second curated step 402 to the third curated step 403. Similar or different jumps or transitions may be set by the user for the transition from the third curated step 403 in FIG. 4C to the fourth curated step 404 in FIG. 4D.

FIG. 4E illustrates a fifth curated step 405, which, in the current example, is the last curated step. After the third curated file 160c and its associated annotations have been consumed by the user (e.g., a set amount of time has passed or the user has indicated an exit from the curated experience), the curated experience may offer the user the option to view the curated experience again, to download the album attachment 170, or to extract the curated files 160 comprising the curated album attachment 170. These options may be presented as actuatable controls 490 within the curated experience, as a dialog in a new window or pane, and may not be presented if the user is viewing the album attachment 170 in a preview mode.

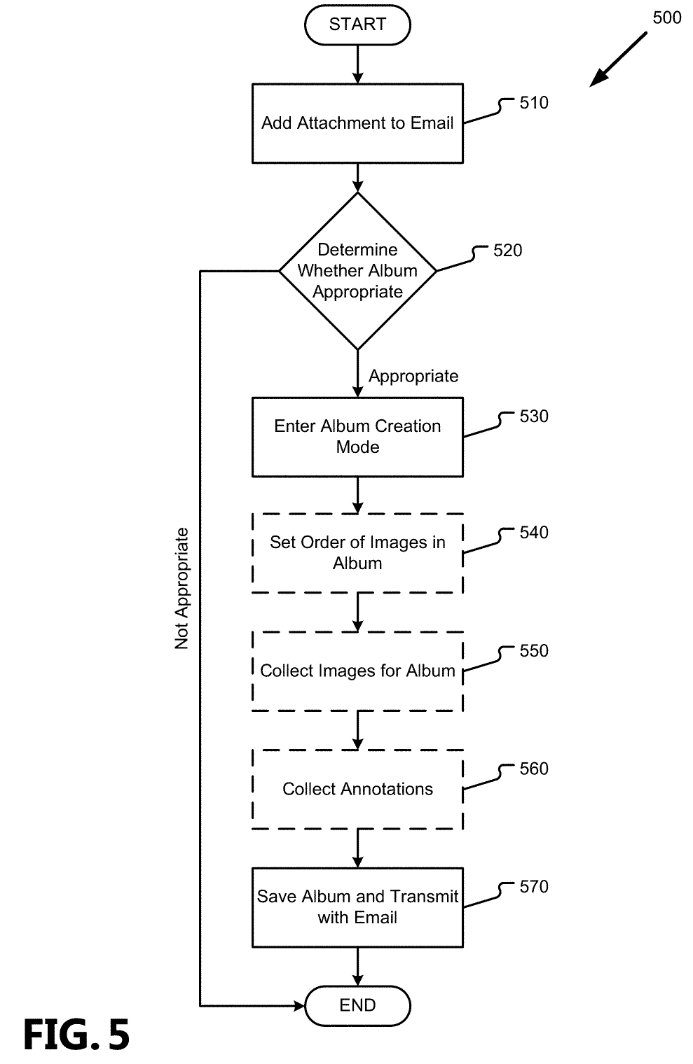

FIG. 5 is a flowchart showing general stages involved in an example method 500 for enabling the curation of albums of images attached with an email. Method 500 begins at OPERATION 510 when attachments are added to an email. Attachments may be added to an email from a file system calling an email application, dragging the files to attach into the email application, or referencing the files from the email client.

Method 500 then proceeds to DECISION 520, where it is determined whether an album experience would be appropriate. In various aspects, the sender email client 120 will determine that an album experience is appropriate based on a number of image files (known by their file extensions) that the user attempts to attach meeting a threshold (e.g., 3, 4, 20, etc., images), a user selecting an album curation interface, or the user referencing a folder or URL for attachment with the email. In various aspects, when the system determines that an album experience is appropriate, the sending user is presented with a dialog from the sender email client 120 to confirm whether the decision to include an album is appropriate. When it is determined that it is not appropriate or desired to use an album attachment 170 to curate the attached files, method 500 may conclude and reinitiate at the next time an attachment is added to an email. Otherwise, when it is determined that it is appropriate to use an album attachment 170, method 500 will proceed to OPERATION 530.

For example, when a sending user attaches a first image and a word processing document, it may be determined at DECISION 520 that it is not appropriate to use an album attachment 170 because the number of attached images does not meet or exceed a threshold to prompt the user to use an album attachment 170 to curate the attached files. Continuing the example, if the user attaches additional image files (e.g., four more image files) sufficient to meet the threshold, the user will be prompted to use an album attachment 170 because the number of attached images now meets or exceeds the threshold. If the user responds to the prompt in the negative, method 500 will conclude and in some aspect may not check with the user again as additional image files are continued to be attached with the current email message 130. If the user responds to the prompt in the affirmative, method 500 will proceed to OPERATION 530. The image files will be considered curated files 160, but the word processor document will be kept as a separate file attachment and therefore not a curated file 160.

At OPERATION 530 the sender email client 120 enters into an album creation mode. An example of an album creation mode is discussed in regard to FIGS. 3A and 3B. When in album creation mode, the sender email client 120 allows the sending user to set an order for the curated files 160 for presentation to the receiving user (OPTIONAL OPERATION 540), to attach additional images for inclusion in the album attachment 170 (OPTIONAL OPERATION 550), and add annotations to the curated files 160 or the album attachment (OPTIONAL OPERATION 560). The album creation mode may be done in a separate UI window or a new pane within a UI for the sender email client 120. The OPTIONAL OPERATIONS 540, 550, and 560 may each be performed multiple times in various arrangements as the sending user crafts and curates the album attachment 170 until the album attachment 170 is saved and transmitted with the email message 130 in OPERATION 570.

At OPTIONAL OPERATION 540 an order for the curated files 160 comprising the album attachment 170 is set. In various aspects, the sender email client 120 may initially use an order of attachment, an alphabetical naming order, a date of creation or modification of the attached files to organize the order of the curated files 160 in the album attachment 170. The sending user may modify this order by dragging the thumbnails of the images in a graphical interface or by specifying a position of the curated files 160 relative to one another. Additionally, the sending user may modify for how long a given view of a curated file 160 is to be displayed to a receiving user, from an initial value of display, which may be configurable within the sender email client 120. A display time may specify a given length of time (e.g., 30 s), an annotation's run time (e.g., display so long as a sound files is not yet complete), or to display until a receiving user indicates that viewing is complete (e.g., sending a “next image” command).

At OPTIONAL OPERATION 550 additional files for inclusion in the album attachment 170 are collected. In various aspects, these files may be indicated by the sending user (by dragging them into the sender email client 120 from a file system, by using a dialog in the sender email client 120, etc.) or may be collected automatically by the sender email client 120 (e.g., when a user has indicated a file system path or URL, all the files located at that location may be collected automatically). In addition, the sender email client 120 may suggest images for inclusion in the album attachment 170, such as for example, the most recent files on a camera device, the remaining images in a file location, images with similar names, etc.

At OPTIONAL OPERATION 560 annotations are collected for inclusion in the album attachment 170. As discussed above, annotations may include text, overlay masks for images, sound files, and zoom/pan directions. The annotations may apply to a single curated file 160, such as, for example, a sound file that plays for the duration that an image file is displayed, or to multiple curated files 160 or the album attachment 170 itself, such as for example, a sound files that plays for the duration that either of two image files are displayed, or a sound file that plays for a set period of time regardless of which image files are displayed. The annotations may be collected from various interfaces within the sender email client 120 when it is in creation mode.

When the sending user is finished curating the album attachment 170, method 500 proceeds to OPERATION 570, where the album attachment 170 is saved and transmitted to the receiving user with the email message 130. As will be appreciated, when the sending user transmits the email message 130, the album attachment 170 and a copy of the email message 130 may be retained on the sender machine 110 (or host of the sender email client 120), and the email message 130 and album attachments 170 may be sent to many receiving users (e.g., via multiple email addresses, a distribution list, automated mail forwarding). Alternatively, the email message 130 and/or the album attachment 170 may be saved as a draft for the sending user to access at a later time to send. The sending user may access saved copies of the email message 130 and the album attachment 170 (e.g., from a draft items folder internal to the email client, from a sent items folder internal to the email client, from a documents folder external to the email client) to make edits to the album attachment 170 or send to additional receiving users. Method 500 then concludes.

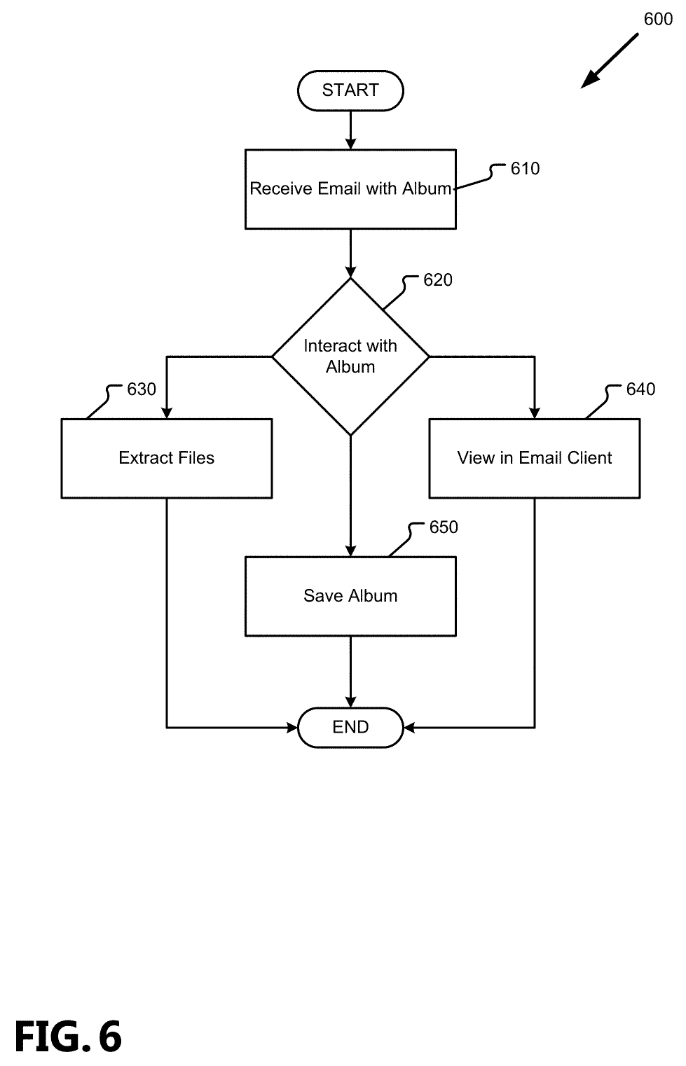

FIG. 6 is a flowchart showing general stages involved in an example method 600 for a receiving user interacting with a curated album of images attached with an email. Method 600 begins when the receiving user receives and opens an email message 130 with which an album attachment 170 is attached. Method 600 then proceeds to DECISION 620, where the user interacts with the album attachment 170 and method 600 may proceed to various operations depending on the signaled interaction from the receiving user.

When it is determined that the receiving user has interacted with the album attachment 170 to extract the curated files 160, method 600 proceeds to OPERATION 630. When the receiving user extracts the curated files 160 from the album attachment 170, the user may specify various locations for the curated files 160 to be saved to that are local to the receiver machine 140 or remote from the receiver machine 140, such as, for example, a network drive or a cloud storage solution. The receiving user may also specify whether the curated files 160 are to be extracted with or without their annotations. For example, sound files or text files that annotate images may be saved in the same location as the curated files 160 by the receiving user, or ignored when extracting the curated files 160. Similarly, when the curated files 160 have been annotated with pen input as masks for the image files, the image files may be saved with the masks applied or without the masks applied, and the user may be provided with “clean” files without the masks, with annotated files (with the masks), and/or with files of just the masks, which may be applied at a later time by the receiving user. When the curated experience includes panning and zooming instructions, the receiving user may save the curated files 160 in their original form, and, optionally, the modified views may be saved as separate images. For example, if a sending user initially shows a first image as zoomed in to a detail, and included zoom and pan instructions to zoom out to the full image, the receiving user could extract the first curated file 160a as the full image and could also extract (if elected) an image of the zoomed-in initial view as a separate file.

When it is determined that the receiving user has interacted with the album attachment 170 to view it in the receiver email client 150, method 600 proceeds to OPERATION 640. As discussed in greater detail regarding FIGS. 4A-E, the receiving user may view the curated album attachment 170 in a full screen mode, within a pane of the receiver email client 150, or in a new window of the receiver email client 150 or a web browser provided by the receiver machine 140. The receiving user may navigate the curated album attachment 170 via various keyboard, mouse, natural user input, and integrated commands, adjust volumes, and exit the curated experience before it is complete. In various aspects, a receiving user who exits the curated experience before its conclusion may resume at a last-viewed position in the experience, at a given image, or at the beginning of the experience.

When it is determined that the receiving user has interacted with the album attachment 170 to save it, method 600 proceeds to OPERATION 650. At OPERATION 650 the album attachment 170 is extracted from the email message 130 and saved to a destination file path of the receiving user's choosing. The receiving user may save the album attachment to the receiver machine 140 or to a remote storage solution, from which the album attachment 170 may be interacted with at a later time and/or attached to a new email message 130.

The receiving user may perform multiple interactions on a single email message 130 (saving and extracting; viewing and extracting; viewing and saving; viewing, saving and extracting) and after performing OPERATIONS 630, 640, and/or 650, may interact with the album attachment 170 or the curated files 160 outside of the receiver email client 150. Method 600 then concludes

While implementations have been described in the general context of program modules that execute in conjunction with an application program that runs on an operating system on a computer, those skilled in the art will recognize that aspects may also be implemented in combination with other program modules. Generally, program modules include routines, programs, components, data structures, and other types of structures that perform particular tasks or implement particular abstract data types.

The aspects and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, according to an aspect, the aspects and functionalities described herein operate over distributed systems (e.g., cloud-based computing systems), where application functionality, memory, data storage and retrieval and various processing functions are operated remotely from each other over a distributed computing network, such as the Internet or an intranet. According to an aspect, user interfaces and information of various types are displayed via on-board computing device displays or via remote display units associated with one or more computing devices. For example, user interfaces and information of various types are displayed and interacted with on a wall surface onto which user interfaces and information of various types are projected. Interaction with the multitude of computing systems with which implementations are practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

FIGS. 7-9 and the associated descriptions provide a discussion of a variety of operating environments in which examples are practiced. However, the devices and systems illustrated and discussed with respect to FIGS. 7-9 are for purposes of example and illustration and are not limiting of a vast number of computing device configurations that are utilized for practicing aspects, described herein.

FIG. 7 is a block diagram illustrating physical components (i.e., hardware) of a computing device 700 with which examples of the present disclosure may be practiced. In a basic configuration, the computing device 700 includes at least one processing unit 702 and a system memory 704. According to an aspect, depending on the configuration and type of computing device, the system memory 704 comprises, but is not limited to, volatile storage (e.g., random access memory), non-volatile storage (e.g., read-only memory), flash memory, or any combination of such memories. According to an aspect, the system memory 704 includes an operating system 705 and one or more program modules 706 suitable for running software applications 750. According to an aspect, the system memory 704 includes the sender email client 120 and/or the receiver email client 150 to enable a software application 750 to employ the teachings of the present disclosure via stored instructions. The operating system 705, for example, is suitable for controlling the operation of the computing device 700. Furthermore, aspects are practiced in conjunction with a graphics library, other operating systems, or any other application program, and is not limited to any particular application or system. This basic configuration is illustrated in FIG. 7 by those components within a dashed line 708. According to an aspect, the computing device 700 has additional features or functionality. For example, according to an aspect, the computing device 700 includes additional data storage devices (removable and/or non-removable) such as, for example, magnetic disks, optical disks, or tape. Such additional storage is illustrated in FIG. 7 by a removable storage device 709 and a non-removable storage device 710.

As stated above, according to an aspect, a number of program modules and data files are stored in the system memory 704. While executing on the processing unit 702, the program modules 706 (e.g., the email clients) perform processes including, but not limited to, one or more of the stages of the methods 500 and 600 illustrated in FIGS. 4 and 5. According to an aspect, other program modules are used in accordance with examples and include applications such as electronic mail and contacts applications, word processing applications, spreadsheet applications, database applications, slide presentation applications, drawing or computer-aided application programs, etc.

According to an aspect, the computing device 700 has one or more input device(s) 712 such as a keyboard, a mouse, a pen, a sound input device, a touch input device, etc. The output device(s) 714 such as a display, speakers, a printer, etc. are also included according to an aspect. The aforementioned devices are examples and others may be used. According to an aspect, the computing device 700 includes one or more communication connections 716 allowing communications with other computing devices 718. Examples of suitable communication connections 716 include, but are not limited to, radio frequency (RF) transmitter, receiver, and/or transceiver circuitry; universal serial bus (USB), parallel, and/or serial ports.

The term computer readable media, as used herein, includes computer storage media apparatuses and articles of manufacture. Computer storage media include volatile and nonvolatile, removable and non-removable media implemented in any method or technology for storage of information, such as computer readable instructions, data structures, or program modules. The system memory 704, the removable storage device 709, and the non-removable storage device 710 are all computer storage media examples (i.e., memory storage). According to an aspect, computer storage media include RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 700. According to an aspect, any such computer storage media is part of the computing device 700. Computer storage media do not include a carrier wave or other propagated data signal.

According to an aspect, communication media are embodied by computer readable instructions, data structures, program modules, or other data in a modulated data signal, such as a carrier wave or other transport mechanism, and include any information delivery media. According to an aspect, the term “modulated data signal” describes a signal that has one or more characteristics set or changed in such a manner as to encode information in the signal. By way of example, and not limitation, communication media include wired media such as a wired network or direct-wired connection, and wireless media such as acoustic, radio frequency (RF), infrared, and other wireless media.

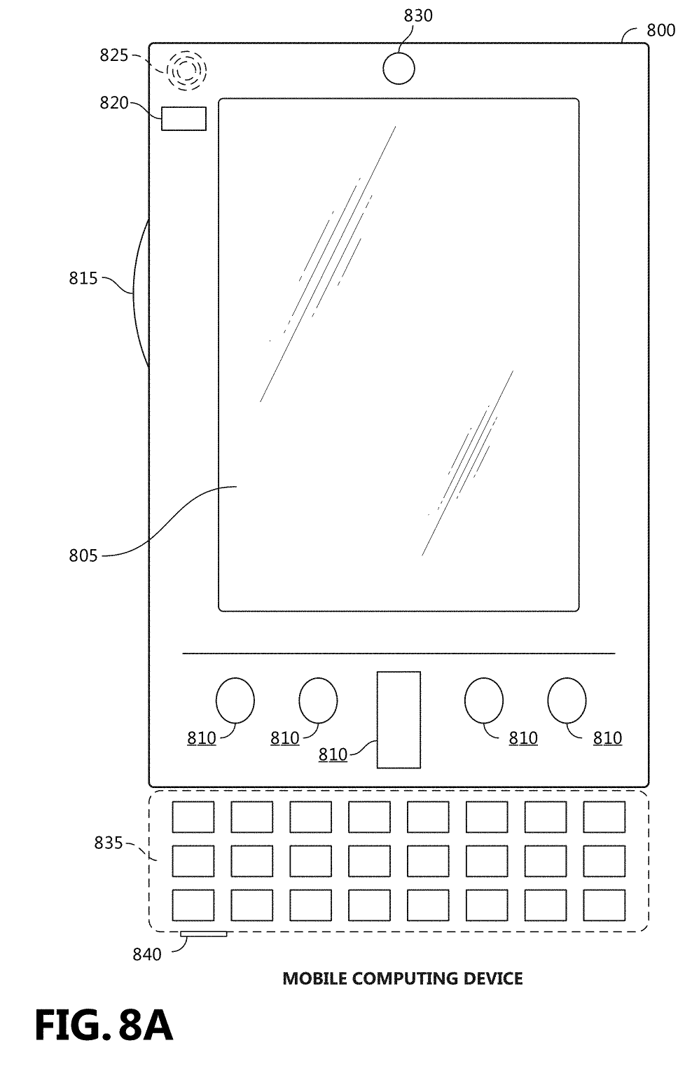

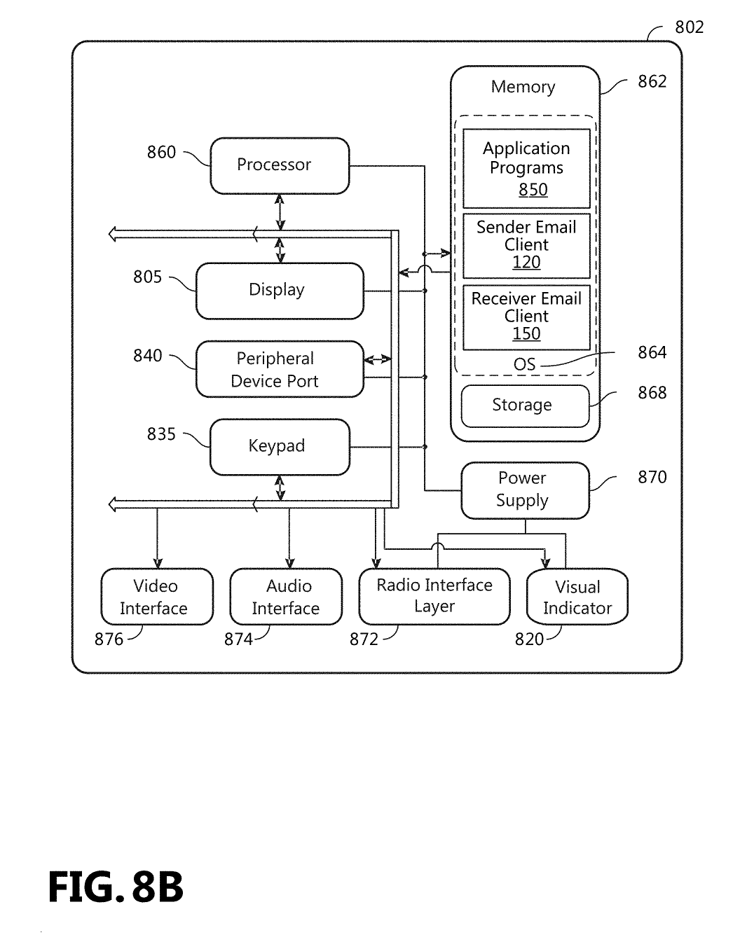

FIGS. 8A and 8B illustrate a mobile computing device 800, for example, a mobile telephone, a smart phone, a tablet personal computer, a laptop computer, and the like, with which aspects may be practiced. With reference to FIG. 8A, an example of a mobile computing device 800 for implementing the aspects is illustrated. In a basic configuration, the mobile computing device 800 is a handheld computer having both input elements and output elements. The mobile computing device 800 typically includes a display 805 and one or more input buttons 810 that allow the user to enter information into the mobile computing device 800. According to an aspect, the display 805 of the mobile computing device 800 functions as an input device (e.g., a touch screen display). If included, an optional side input element 815 allows further user input. According to an aspect, the side input element 815 is a rotary switch, a button, or any other type of manual input element. In alternative examples, mobile computing device 800 incorporates more or fewer input elements. For example, the display 805 may not be a touch screen in some examples. In alternative examples, the mobile computing device 800 is a portable phone system, such as a cellular phone. According to an aspect, the mobile computing device 800 includes an optional keypad 835. According to an aspect, the optional keypad 835 is a physical keypad. According to another aspect, the optional keypad 835 is a “soft” keypad generated on the touch screen display. In various aspects, the output elements include the display 805 for showing a graphical user interface (GUI), a visual indicator 820 (e.g., a light emitting diode), and/or an audio transducer 825 (e.g., a speaker). In some examples, the mobile computing device 800 incorporates a vibration transducer for providing the user with tactile feedback. In yet another example, the mobile computing device 800 incorporates a peripheral device port 840, such as an audio input (e.g., a microphone jack), an audio output (e.g., a headphone jack), and a video output (e.g., a HDMI port) for sending signals to or receiving signals from an external device.

FIG. 8B is a block diagram illustrating the architecture of one example of a mobile computing device. That is, the mobile computing device 800 incorporates a system (i.e., an architecture) 802 to implement some examples. In one example, the system 802 is implemented as a “smart phone” capable of running one or more applications (e.g., browser, e-mail, calendaring, contact managers, messaging clients, games, and media clients/players). In some examples, the system 802 is integrated as a computing device, such as an integrated personal digital assistant (PDA) and wireless phone.

According to an aspect, one or more application programs 850 are loaded into the memory 862 and run on or in association with the operating system 864. Examples of the application programs include phone dialer programs, e-mail programs, personal information management (PIM) programs, word processing programs, spreadsheet programs, Internet browser programs, messaging programs, and so forth. According to an aspect, a sender email client 120 or a receiver email client 150 is loaded into memory 862. The system 802 also includes a non-volatile storage area 868 within the memory 862. The non-volatile storage area 868 is used to store persistent information that should not be lost if the system 802 is powered down. The application programs 850 may use and store information in the non-volatile storage area 868, such as e-mail or other messages used by an e-mail application, and the like. A synchronization application (not shown) also resides on the system 802 and is programmed to interact with a corresponding synchronization application resident on a host computer to keep the information stored in the non-volatile storage area 868 synchronized with corresponding information stored at the host computer. As should be appreciated, other applications may be loaded into the memory 862 and run on the mobile computing device 800.

According to an aspect, the system 802 has a power supply 870, which is implemented as one or more batteries. According to an aspect, the power supply 870 further includes an external power source, such as an AC adapter or a powered docking cradle that supplements or recharges the batteries.

According to an aspect, the system 802 includes a radio 872 that performs the function of transmitting and receiving radio frequency communications. The radio 872 facilitates wireless connectivity between the system 802 and the “outside world,” via a communications carrier or service provider. Transmissions to and from the radio 872 are conducted under control of the operating system 864. In other words, communications received by the radio 872 may be disseminated to the application programs 850 via the operating system 864, and vice versa.

According to an aspect, the visual indicator 820 is used to provide visual notifications and/or an audio interface 874 is used for producing audible notifications via the audio transducer 825. In the illustrated example, the visual indicator 820 is a light emitting diode (LED) and the audio transducer 825 is a speaker. These devices may be directly coupled to the power supply 870 so that when activated, they remain on for a duration dictated by the notification mechanism even though the processor 860 and other components might shut down for conserving battery power. The LED may be programmed to remain on indefinitely until the user takes action to indicate the powered-on status of the device. The audio interface 874 is used to provide audible signals to and receive audible signals from the user. For example, in addition to being coupled to the audio transducer 825, the audio interface 874 may also be coupled to a microphone to receive audible input, such as to facilitate a telephone conversation. According to an aspect, the system 802 further includes a video interface 876 that enables an operation of an on-board camera 830 to record still images, video stream, and the like.

According to an aspect, a mobile computing device 800 implementing the system 802 has additional features or functionality. For example, the mobile computing device 800 includes additional data storage devices (removable and/or non-removable) such as, magnetic disks, optical disks, or tape. Such additional storage is illustrated in FIG. 8B by the non-volatile storage area 868.

According to an aspect, data/information generated or captured by the mobile computing device 800 and stored via the system 802 are stored locally on the mobile computing device 800, as described above. According to another aspect, the data are stored on any number of storage media that are accessible by the device via the radio 872 or via a wired connection between the mobile computing device 800 and a separate computing device associated with the mobile computing device 800, for example, a server computer in a distributed computing network, such as the Internet. As should be appreciated, such data/information are accessible via the mobile computing device 800 via the radio 872 or via a distributed computing network. Similarly, according to an aspect, such data/information are readily transferred between computing devices for storage and use according to well-known data/information transfer and storage means, including electronic mail and collaborative data/information sharing systems.

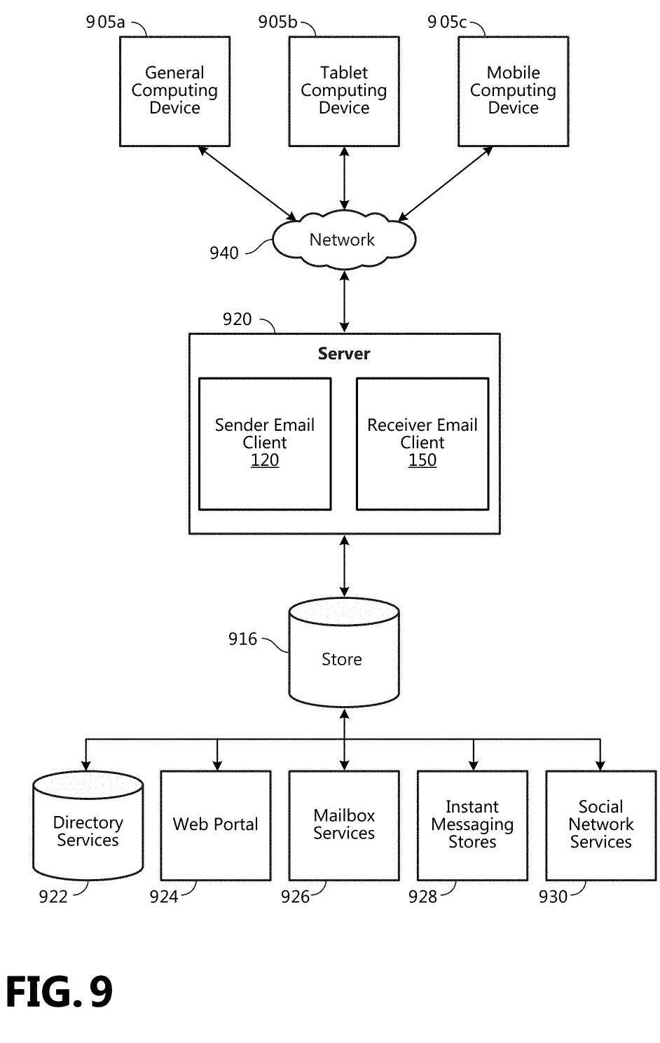

FIG. 9 illustrates one example of the architecture of a system for automatic presentation of blocks of repeated content as described above. Content developed, interacted with, or edited in association with the curated experience is enabled to be stored in different communication channels or other storage types. For example, various documents may be stored using a directory service 922, a web portal 924, a mailbox service 926, an instant messaging store 928, or a social networking site 930. The sender email client 120 is operative to use any of these types of systems or the like for distribution of curated album attachments 170, as described herein. According to an aspect, a server 920 provides the email applications to clients 905a-c (generally clients 905), which may be sender machines 110 or receiver machines 140. As one example, the server 920 is a web server providing the email clients 120, 150 over the web. The server 920 provides the email clients 120, 150 over the web to clients 905 through a network 940. By way of example, the client computing device is implemented and embodied in a personal computer 905a, a tablet computing device 905b or a mobile computing device 905c (e.g., a smart phone), or other computing device. Any of these examples of the client computing device are operable to obtain content from the store 916.

Implementations, for example, are described above with reference to block diagrams and/or operational illustrations of methods, systems, and computer program products according to aspects. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more examples provided in this application are not intended to limit or restrict the scope as claimed in any way. The aspects, examples, and details provided in this application are considered sufficient to convey possession and enable others to make and use the best mode. Implementations should not be construed as being limited to any aspect, example, or detail provided in this application. Regardless of whether shown and described in combination or separately, the various features (both structural and methodological) are intended to be selectively included or omitted to produce an example with a particular set of features. Having been provided with the description and illustration of the present application, one skilled in the art may envision variations, modifications, and alternate examples falling within the spirit of the broader aspects of the general inventive concept embodied in this application that do not depart from the broader scope of the present disclosure.

We claim:

1. A method for enabling curation of an album comprising a plurality of images attached with an email message, comprising:
receiving, in an email client, a plurality of image files to curate as part of the album;
receiving, in the email client, an annotation to apply to at least one of the image files;
applying, by the email client, the annotation to the at least one of the image files;
saving, by the email client, the plurality of image files and the annotation in the album as a single file; and
attaching, by the email client, the album to the email message;
transmitting, by the email client, the email message to a recipient.

2. The method of claim 1, wherein the recipient is enabled to open the album in a receiver email client to view the plurality of image files and the annotation in association with each other.

3. The method of claim 1, wherein the annotation comprises pen input, applied to the at least one of the image files as a mask, wherein the mask is dimensioned according to the at least one of the image files and is transparent except where a sending user applied the pen input in the email client.

4. The method of claim 1, wherein the single file is formatted according to the Hypertext Markup Language (HTML) as an HTML object.

5. The method of claim 1, wherein the annotation comprises a sound file.

6. The method of claim 5, wherein the sound file is associated with the album and not with a given image file of the plurality of image files.

7. The method of claim 5, wherein the sound file is associated with one image of the image files, wherein during viewing of the album by the recipient, a next image of the plurality of the plurality of images is displayed in response to the sound file completing.

8. The method of claim 1, wherein the annotation is applied to one image file of the plurality of image files.

9. The method of claim 8, wherein a second annotation is applied to the one image file.

10. The method of claim 1, further comprising:
setting an order of display of the plurality of image files; and
setting a pace for plurality of images to be displayed according to the order.

11. The method of claim 1, wherein the annotation specifies pan and zoom settings for the at least one of the image files.

12. A system enabled to curate an album comprising a plurality of images for attachment to with an email message, comprising:
a processing unit; and
a system memory including instruction that when performed by the processing unit provide a graphical user interface as part of a sender email client including:
a message authoring panel in which to author the email message; and
an album building panel in which to apply annotations to at least one image of the plurality of images, wherein the album building panel includes:
an image preview for each image of the plurality of images, operative to display an associated image and any annotations of the applied annotations applied to the associated image;
image controls to define the annotations to apply to a given image of the plurality of images; and
cross-image controls to define the annotations to apply across multiple images of the plurality of images.

13. The system of claim 12, wherein the sender email client is a cloud-based application.

14. The system of claim 12, wherein the graphical user interface further includes album controls, operative to specify additional images to add to the plurality of images as part of the album.

15. The system of claim 12, wherein an order of image previews in the album building panel specify an order of presentation of the plurality of images in the album.

16. The system of claim 12, wherein the image controls include:
zoom and pan controls;
highlight controls;
text controls; and
timing controls.

17. A method for enabling curation of an album comprising a plurality of images and annotations attached with an email message, comprising:
receiving, in an email client, the email message;
receiving, in the email client, user interactions to view the album in the email client;
displaying, in the email client, the plurality of images according to an order of display set for the plurality of images in the album; and
presenting, in the email client, the annotations in conjunction with associated images displayed from the plurality of images, wherein the annotations are associated with one or more images of the plurality of images and at least one annotation is presented across more than one image.

18. The method of claim 17, wherein the at least one annotation that is presented across more than one image is an audio file.

19. The method of claim 17, wherein a given annotation presented in conjunction with an associated image of the plurality of images comprises visual annotations of pen input highlighting or text is applied as a mask over the associated image.

20. The method of claim 19, further comprising:
receiving, in the email client, user interactions to download the album from the email message;
determining a location to which to save the plurality of images;
determining whether to save the plurality of images with annotations or without annotations;
in response to determining to save the plurality of images with annotations, saving the plurality of images to the location with the mask of the visual annotation applied to the associated image; and
in response to determining to save the plurality of images without annotations, saving the plurality of images to the location without the mask of the visual annotation applied to the associated image.
